(19) United States
(12) Patent Application Publication
(10) Pub. No.: US 2026/0198483 A1
(43) Pub. Date: Jul. 16, 2026

(54) PARATHYROID GLAND PERFUSION PRESERVATION DEVICE

(71) Applicants: Guangdong University of Petrochemical Technology, Maoming (CN); Guangdong Medical University, Zhanjiang (CN)

(72) Inventors: Xingang Wang, Maoming (CN); Zhuo Jin, Zhanjiang (CN); Huawei Zhang, Maoming (CN); Ziqiu He, Maoming (CN); Peiyi Li, Maoming (CN); Junhua Li, Maoming (CN); Jingjing Bai, Maoming (CN); Mingxi Liang, Maoming (CN); Haiyue Li, Maoming (CN)

(21) Appl. No.: 19/302,004

(22) Filed: Aug. 17, 2025

(30) Foreign Application Priority Data
Jan. 14, 2025 (CN) 202510051667.2

(51) Int. Cl. A01N 1/143

(52) U.S. Cl. CPC A01N 1/143

(57) ABSTRACT

A parathyroid gland perfusion preservation device is provided, which relates to the field of human organ preservation technologies. The device includes a parathyroid gland preservation box, a perfusion liquid circulation system and a control system. The parathyroid gland preservation box defines a space for placing parathyroid glands. The perfusion liquid circulation system is connected to the parathyroid glands stored in the parathyroid gland preservation box through inlet pipes, indwelling needles and a reflux pipe to supply perfusion liquid to the parathyroid glands. The control system is electrically connected to components of the perfusion liquid circulation system, and configured to receive a working state signal of the components of the perfusion liquid circulation system, and send a control instruction to the components of the perfusion liquid circulation system according to the working state signal. The device can achieve in vitro preservation of parathyroid glands, and can effectively protect the parathyroid glands.

### CROSS-REFERENCE TO RELATED APPLICATION

This application claims priority to Chinese Patent Application No. 202510051667.2, filed on January 14, 2025, which is herein incorporated by reference in its entirety.

### TECHNICAL FIELD

The disclosure relates to the field of human organ preservation technologies, and more particularly to a parathyroid gland perfusion preservation device.

### BACKGROUND

In general, parathyroid gland is an importance gland for human body, and is one of endocrine glands in the human body. Parathyroid transplantation is a technology that protects or restores a function of the parathyroid glands of a patient during thyroid surgery. The parathyroid transplantation requires a design of in vitro preservation technology. Existing in vitro preservation device of the parathyroid glands is difficult to effectively protect the parathyroid glands, and the parathyroid glands are small in size and are not easy to preservation in vitro. There is also a lack of devices specifically designed for in vitro preservation of the parathyroid glands.

### SUMMARY

In order to solve the above problems, the disclosure proposes a parathyroid gland perfusion preservation device, which can achieve in vitro preservation of parathyroid glands, and can effectively protect the parathyroid glands.

In order to achieve the above purpose, technical solutions adopted by the disclosure are as follows.

A parathyroid gland perfusion preservation device includes a parathyroid gland preservation box, a perfusion liquid circulation system and a control system. The parathyroid gland preservation box defines a space therein for placing isolated parathyroid glands. The perfusion liquid circulation system is connected to the isolated parathyroid glands stored in the parathyroid gland preservation box through inlet pipes, indwelling needles and a reflux pipe to supply perfusion liquid to the isolated parathyroid glands. The control system is electrically connected to components of the perfusion liquid circulation system. The control system is configured to receive a working state signal of the components of the perfusion liquid circulation system, and send a control instruction to the components of the perfusion liquid circulation system according to the working state signal.

In an embodiment, the perfusion liquid circulation system includes two circulation pipelines, and the two circulation pipelines include a first circulation pipeline and a second circulation pipeline. The first circulation pipeline is a first inlet pipe, and a first perfusion pump, a defoaming and oxygen exchange component, a first pressure gauge and a first flowmeter are sequentially disposed on the first inlet pipe in that order from a reflux direction to a supply direction. The second circulation pipeline is a second inlet pipe, and a second perfusion pump, a defoaming component, a second pressure gauge and a second flowmeter are sequentially disposed on the second inlet pipe in that order from the reflux direction to the supply direction.

In an embodiment, the first circulation pipeline and the second circulation pipeline share the reflux pipe. A thermometer is disposed on the reflux pipe and configured to detect a temperature of refluxed perfusion liquid, and the thermometer is electrically connected to the control system.

In an embodiment, the parathyroid gland preservation box has multiple groups of slide columns and thyroid simulation mechanisms therein. Each of the thyroid simulation mechanisms includes multiple preservation cages, and each of the multiple preservation cages includes two slide rings and multiple protective sheets. The two slide rings are sleeved outside a corresponding one of the slide columns, and each of the multiple protective sheets is divided into an upper protective sheet and a lower protective sheet. An upper end of the upper protective sheet is pivotally connected to an upper one of the two slide rings, and a lower end of the lower protective sheet is pivotally connected to a lower one of the two slide rings. The upper protective sheet and the lower protective sheet are the same in quantity and opposite to each other one by one. A lower end of the upper protective sheet and an upper end of the lower protective sheet are pivotally connected to each other through a protective sheet hinge structure, so that each of the multiple preservation cages form a telescopic cage structure.

In an embodiment, the lower one of the two slide rings below the preservation cage is fixed on the corresponding one of the slide columns, and the upper one of the two slide rings above the preservation cage is in sliding connection with the corresponding one of the slide columns.

In an embodiment, a limiting structure is installed on each of the slide columns, and is configured to limit a height position of the upper one of the two slide rings.

In an embodiment, the limiting structure is an elastic buckle returnable into the slide column.

In an embodiment, a protective box in a four-leaf petal shape is disposed inside each of the thyroid type simulation mechanisms on each of the slide columns.

In an embodiment, a method for using the parathyroid gland perfusion preservation device includes the follows.

The control system obtains a working state of the perfusion liquid circulation system, to make information (i.e., pressure) of the perfusion liquid within a preset range, including the follows.

Pressure of the perfusion liquid is obtained through the first pressure gauge and the second pressure gauge. When the pressure exceeds the preset range, a flow rate of the perfusion liquid is adjusted by perfusion pumps (i.e., the first perfusion pump and the second perfusion pump). The preset range is 60 millimeters of mercury (mmHg) to 80 mmHg within a first time period, and the preset range is 160 mmHg to 180 mmHg within a second time period.

The first perfusion pump of the first circulation pipeline perfuses once every 18 hours (h), for a duration of 40 minutes (min), and the second perfusion pump of the second circulation pipeline replaces fresh perfusion liquid every 18 h, and a conveying speed of the perfusion liquid is 0.370 milliliters per minute (mL/min).

Beneficial effects of using the disclosure are as follows.

The parathyroid gland perfusion preservation device disclosed by the disclosure uses the first circulation pipeline and the second circulation pipeline to convey nutrient solution (i.e., the perfusion liquid), and controls a speed of peristaltic pumps (i.e., the first perfusion pump and the second perfusion pump) to adjust the flow rate, thereby maintaining constant pressure perfusion. For example, a perfusion pressure is set, when the perfusion pressure exceeds a threshold (i.e., the preset range), the peristaltic pumps are immediately stopped, and the peristaltic pumps are controlled to stabilize the perfusion pressure at a set value. Meanwhile, the control system can detect the temperature of the perfusion liquid in real time, when the temperature is too high, an alarm prompt will be triggered. In addition, the control system can also have a timing function. A segmented perfusion mode is set, that is, multiple constant pressure perfusion stages and a duration corresponding to each constant pressure perfusion stage can be set at the same time. The disclosure can regulate the flow rate, the pressure and the temperature of the two independent perfusion pipelines (i.e., the first circulation pipeline and the second circulation pipeline) in real time, and can also store each parameter in real time during operation, with strong stability and repeatability.

In addition, when the thyroid simulation mechanisms preserve the parathyroid glands, if the protective boxes are not locked, the parathyroid glands will become free under an action of preservation fluid (i.e., the perfusion liquid). The freedom will cause collisions between the parathyroid glands, which will damage structures of the parathyroid glands and be detrimental to the preservation of the parathyroid glands. The thyroid simulation mechanisms can prevent the parathyroid glands from colliding with each other during the preservation process, which is beneficial to the preservation of the parathyroid glands from a mechanical point of view.

### BRIEF DESCRIPTION OF DRAWINGS

FIG. 1 illustrates a schematic diagram of a parathyroid gland perfusion preservation device according to the disclosure.

FIG. 2 illustrates a schematic diagram of a cooperation between a slide column and a sliding ring in FIG. 1 according to the disclosure.

FIG. 3 illustrates another schematic diagram of the cooperation between the slide column and the sliding ring according to the disclosure.

FIG. 4 illustrates a schematic diagram of the cooperation between the slide column and the sliding ring in another state according to the disclosure.

FIG. 5 illustrates a schematic diagram of a cooperation between the slide column and a thyroid simulation mechanism according to the disclosure.

FIG. 6 illustrates a schematic diagram of a protective box according to the disclosure.

FIG. 7 illustrates an axial schematic diagram of the parathyroid gland perfusion preservation device according to the disclosure.

### Description of reference signs:

1-control system; 2-first perfusion pump; 3-defoaming and oxygen exchange component; 4-first pressure gauge; 5-first flowmeter; 6-second perfusion pump; 7-defoaming component; 8-second pressure gauge; 9-second flowmeter; 10-thermometer; 11-reflux pipe; 12-second inlet pipe; 13-first inlet pipe; 14-slide column; 141-elastic buckle; 15-thyroid simulation mechanism; 151-slide ring; 152-pretective sheet; 1521-upper protective sheet; 1522-lower protective sheet; 153-protective sheet hinge structure; 16-parathyroid gland preservation box; 17-protective case; 18-protective box; 19-case body; 20-case door.

### DETAILED DESCRIPTION OF EMBODIMENTS

In order to make purpose, technical solution and advantages of the disclosure more clear, the disclosure is further described in detail below in conjunction with specific implementation methods. It should be understood that these descriptions are merely exemplary and are not intended to limit a scope of the disclosure.

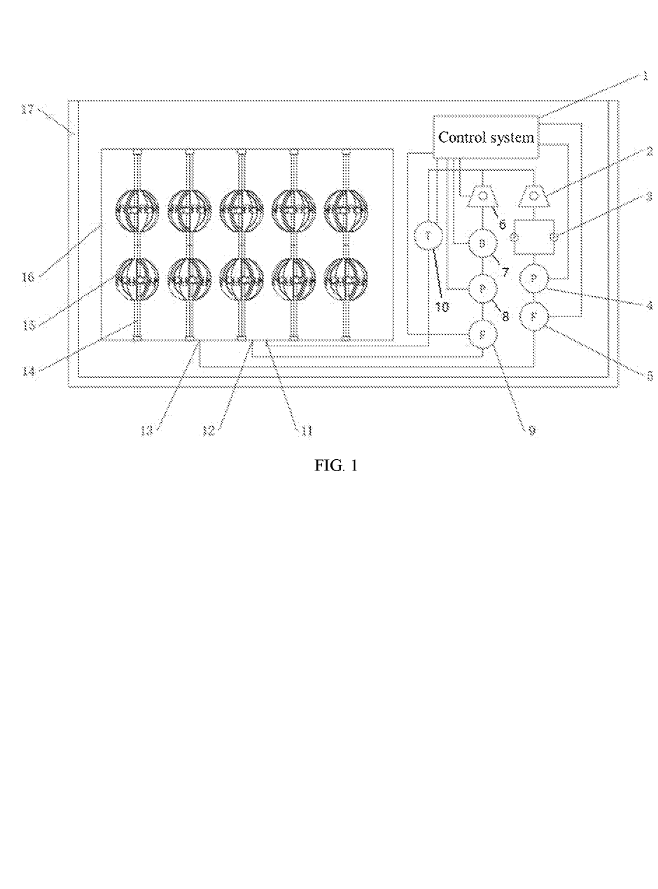

In order to solve a problem that parathyroid glands are small in size and difficult to preserve in vitro in the related art, and there is a lack of devices specifically designed for the in vitro preservation of the parathyroid glands, as shown in FIG. 1, the embodiment proposes a parathyroid perfusion preservation device, which can achieve the in vitro preservation of the parathyroid glands, and can effectively protect the parathyroid glands.

Specifically, in the embodiment, an exterior of the parathyroid gland perfusion preservation device is a protective case 17, and an interior of the parathyroid gland perfusion preservation device is a parathyroid gland preservation box 16. Five slide columns 14 are disposed inside the parathyroid gland preservation box 16, and each slide column 14 is provided with thyroid simulation mechanisms 15. The thyroid simulation mechanisms 15 are used to simulate a state of thyroid gland, and can place isolated parathyroid glands inside it. In the embodiment, each slide column 14 is provided with two thyroid simulation mechanisms 15.

A control system 1 and a perfusion liquid circulation system are disposed outside the parathyroid gland preservation box 16. Specifically, the perfusion liquid circulation system in the embodiment includes two circulated perfusion liquid circulation pipelines. The first pipeline (i.e., first circulation pipeline) is a first inlet pipe 13, and a first perfusion pump 2, a defoaming and oxygen exchange component 3, a first pressure gauge 4 and a first flowmeter 5 are sequentially disposed on the first inlet pipe 13 in that order in a flow direction of the perfusion liquid. The second pipeline (i.e., second circulation pipeline) is a second inlet pipe 12, and a second perfusion pump 6, a defoaming component 7, a second pressure gauge 8 and a second flowmeter 9 are sequentially disposed on the second inlet pipe 12 in that order in the flow direction of the perfusion liquid. Output ends of the first inlet pipe 13 and the second inlet pipe 12 are connected to the thyroid simulation mechanisms 15. The perfusion liquid input through the first inlet pipe 13 and the second inlet pipe 12 passes through the thyroid simulation mechanisms 15 and returns to the first inlet pipe 13 and the second inlet pipe 12 through a reflux pipe 11, that is, the first inlet pipe 13 and the second inlet pipe 12 are connected to the reflux pipe 11 through a three-way pipe. A thermometer 10 is disposed on the reflux pipe 11.

The control system 1 is a main control system, and is configured to control working states of all components (i.e., the first perfusion pump 2, the defoaming and oxygen exchange component 3, the first pressure gauge 4, the first flowmeter 5, the second perfusion pump 6, the defoaming component 7, the second pressure gauge 8, the second flowmeter 9 and the thermometer 10) on the perfusion liquid circulation system, and monitor the working states of all components. In the embodiment, the control system 1 is electrically connected to the first perfusion pump 2, the defoaming and oxygen exchange component 3, the first pressure gauge 4, the first flowmeter 5, the second perfusion pump 6, the defoaming component 7, the second pressure gauge 8, the second flowmeter 9 and the thermometer 10. In addition, the defoaming and oxygen exchange component 3 is disposed on the first inlet pipe 13, and the defoaming component 7 is disposed on the second inlet pipe 12. The defoaming component 7 includes a gas-liquid separator or an exhaust valve.

The above parathyroid gland perfusion preservation device can execute a parathyroid gland perfusion preservation method. The parathyroid gland perfusion preservation method includes placing the isolated parathyroid glands in the thyroid simulation mechanisms, and connecting perfusion pipes with the isolated parathyroid glands; starting the control system 1, to make the perfusion liquid enter the perfusion pipes; and obtaining information of the perfusion liquid through a monitoring module, when the information exceeds a preset range, adjusting the information through the control system 1, to make the information within the preset range.

The perfusion pipes include the first inlet pipe 13, the second inlet pipe 12 and the reflux pipe 11. An end of the first inlet pipe 13 is provided with a first connection member connected to the isolated parathyroid glands, and another end of the first inlet pipe 13 is connected to the reflux pipe 11. An end of the second inlet pipe 12 is provided with a second connection member connected to the isolated parathyroid glands, and another end of the second inlet pipe 12 is connected to the reflux pipe 11. The first connection member and the second connection member are connected to two opposite ends of each parathyroid gland. The perfusion pumps are started to make the perfusion liquid enter the first inlet pipe 13 and the second inlet pipe 12 individually. The perfusion liquid is subjected to defoaming treatment through the defoaming component, and the oxygen exchange component is used to maintain an oxygen content of the first inlet pipe 13.

The information of the perfusion liquid is obtained through the monitoring module, to make the information within the preset range, including the follows. The pressure of the perfusion liquid is obtained through the pressure gauges (i.e., the first pressure gauge 4 and the second pressure gauge 8). When the pressure exceeds the preset range, a flow rate of the perfusion liquid is adjusted by the perfusion pumps (i.e., the first perfusion pump 2 and the second perfusion pump 6). The preset range is 60 mmHg to 80 mmHg within a first time period, and the preset range is 160 mmHg to 180 mmHg within a second time period. A conveying time of the perfusion liquid is controlled and the perfusion liquid is replaced through the perfusion pumps, so that the obtained result (i.e., the information) of the perfusion liquid is within the preset range. Specifically, the first perfusion pump 2 on the first inlet pipe 13 perfuses once every 18 h, for a duration of 40 min, and the second perfusion pump 6 on the second inlet pipe 12 replaces fresh perfusion liquid every 18 h, and a conveying speed of the perfusion liquid is 0.370 mL/min.

The above parathyroid gland perfusion preservation device is described in detail below.

The control system 1 further includes a thermostat, and the thermostat can be consisting of a semiconductor temperature control component, a semiconductor driving component, an aluminum plate, and a negative temperature coefficient (NTC) temperature sensor. The control system 1 can control the temperature of the perfusion liquid to reach the set value by emitting pulse width modulation (PWM) waves to the semiconductor driving component and based on the temperature of the perfusion liquid collected by the NTC temperature sensor.

The parathyroid gland preservation box 16 is used to hold the perfusion fluid, and the thyroid simulation mechanisms 15 are used to place the isolated parathyroid glands. The perfusion pipes are perfusion passages connected between the parathyroid gland preservation box 16 and the thyroid simulation mechanisms 15 for conveying the perfusion liquid to the isolated parathyroid glands. The perfusion pipelines include the first inlet pipe 13 and the second inlet pipe 12 connected between the parathyroid gland preservation box 16 and the thyroid simulation mechanisms 15.

Referring to FIG. 1, the first inlet pipe 13 of the first perfusion passage (i.e., the first circulation pipeline) can be formed by multiple short pipes sequentially connected, and the defoaming and oxygen exchange component 3, the first perfusion pump 2, the first flowmeter 5, and the first pressure gauge 4 are installed on a connection between two adjacent short pipes. The defoaming and oxygen exchange component 3 is used to remove bubbles from the perfusion liquid, and keep an oxygen content in the perfusion liquid. The first perfusion pump 2 is used to drive the perfusion liquid to enter the first inlet pipe 13. The thermometer 10 is used to monitor the temperature of the perfusion liquid in the first inlet pipe 13, the first flowmeter 5 is used to monitor the flow rate of the perfusion liquid in the first inlet pipe 13, and the first pressure gauge 4 is used to monitor the pressure of the perfusion liquid in the first inlet pipe 13. The second perfusion passage (i.e., the second circulation pipeline) can include the defoaming component 7, the second perfusion pump 6, the second flowmeter 9, the second pressure gauge 8 and the thermometer 10. An outlet end of the second inlet pipe 12 can extend into the thyroid simulation mechanisms, and is connected to the isolated parathyroid glands through the second connection member.

In the embodiment of the disclosure, except for the structural differences of the defoaming and oxygen exchange component 3 of the first inlet pipe 13, the structure of the first perfusion passage can be consistent with that of the second perfusion passage. In the second perfusion passage, a layout of the second inlet pipe 12, the structure of other components, and the installation method of each component on the second inlet pipe 12 are consistent with the first perfusion passage mentioned above. However, the second perfusion pump 6 on the second inlet pipe 12 has a different function from the first perfusion pump 2 on the first inlet pipe 13. The function of the second perfusion pump 6 is to replace the perfusion liquid according to the set time and maintain the freshness of the perfusion liquid.

The defoaming and oxygen exchange component 3 and the defoaming component 7 can select the gas-liquid separator and the exhaust valve. The first perfusion pump 2 and the second perfusion pump 6 can adopt a peristaltic pump. The first flowmeter 5 and the second flowmeter 9 can select a rotameter. The first pressure gauge 4 and the second pressure gauge 8 can select a mechanical gauge. The first connection member and the second connection member can adopt an indwelling needle.

Specifically, in the embodiment of the disclosure, the pressure of the perfusion liquid can be obtained through the pressure gauges. When the pressure exceeds the preset range, the flow rate of the perfusion liquid is adjusted by the perfusion pumps, to make the pressure within the preset range. The preset range makes the conveying speed at 0.370 mL/min. A first monitoring module and a second monitoring module can respectively monitor the temperature, the pressure and the flow rate of the perfusion liquid in the first inlet pipe 13 and the second inlet pipe 12. According to the monitoring data of the first monitoring module, the control system 1 controls the pressure of the perfusion liquid in the inlet pipes in real time. The first perfusion pump 2 needs to control the infusion time, with each infusion lasting 20 min and the perfusion liquid replaced every 18 h, and a first perfusion liquid can be an oxygen-carrying perfluorocarbon (PFC) liquid. The second perfusion pump 6 needs to discharge the perfusion liquid in the parathyroid gland preservation box 16 every 18 h and replace it with fresh liquid. A maximum preservation time for the entire device is 72 h.

More specifically, under the action of the first perfusion pump 2, the perfusion liquid in the thyroid simulation mechanisms 15 enters the first inlet pipe 13, and after being defoamed by the defoaming component 7, it enters the isolated parathyroid glands from a first indwelling needle. Before the perfusion liquid reaches the parathyroid glands, the first monitoring module detects the temperature, the pressure and the flow rate of the perfusion liquid, and sends the detected information to the control system 1. The control system 1 compares the detected value (i.e., detected information) with the preset value, and adjusts the detected value to match the preset value in real time by controlling a working frequency of the first perfusion pump 2. A second perfusion liquid can be a university of Wisconsin (UW) solution, and the process of the second inlet pipe 12 is similar, which will not be repeated here. However, the second perfusion pump 6 needs to replace the perfusion liquid to keep freshness of the perfusion liquid. The parathyroid gland perfusion preservation device of the disclosure uses the first perfusion passage and the second perfusion passage to covey nutrient solution (i.e., the perfusion liquid), and controls a speed of peristaltic pumps (i.e., the first perfusion pump 2 and the second perfusion pump 6) to adjust the flow rate, thereby maintaining constant pressure perfusion. For example, a perfusion pressure is set, when the perfusion pressure exceeds a threshold, the peristaltic pumps are immediately stopped, and the peristaltic pumps are controlled to stabilize the perfusion pressure at a set value. Meanwhile, the control system 1 can detect the temperature of the perfusion liquid in real time, when the temperature is too high, an alarm prompt will be triggered. In addition, the control system 1 can also have a timing function. A segmented perfusion mode is set, that is, multiple constant pressure perfusion stages and a duration corresponding to each constant pressure perfusion stage can be set at the same time. The disclosure can regulate the flow rate, the pressure and the temperature of the two independent perfusion pipelines (i.e., the first circulation pipeline and the second circulation pipeline) in real time, and can also store each parameter in real time during operation, with strong stability and repeatability.

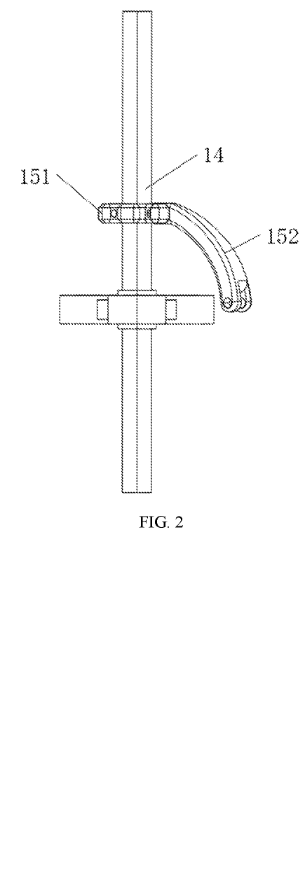

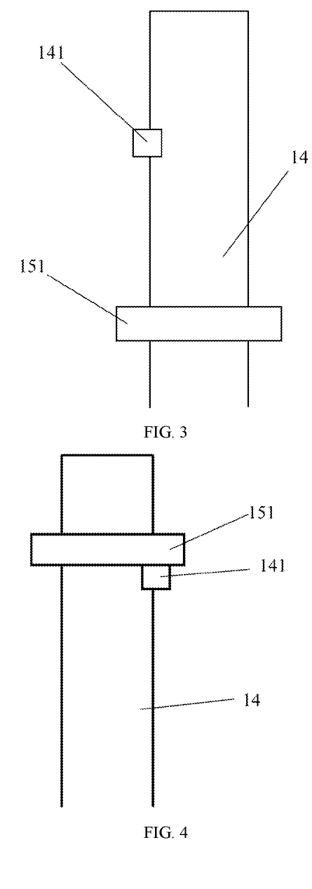

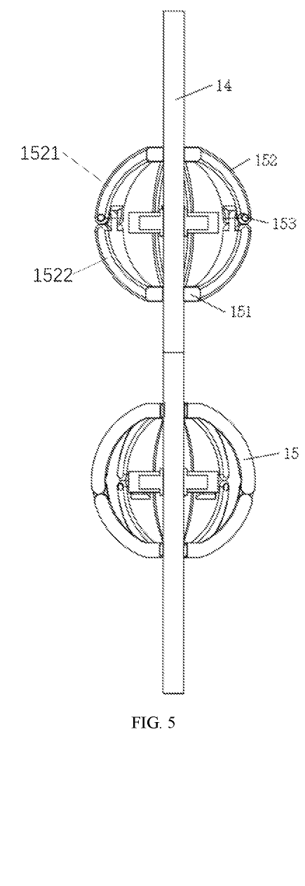

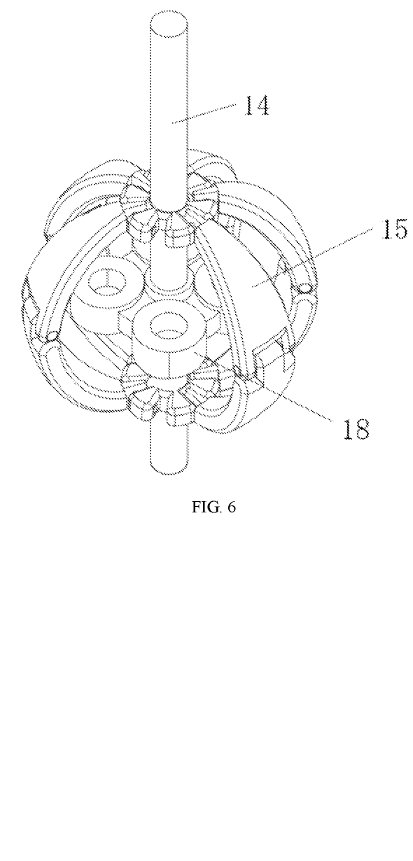

As shown in FIG. 2 to FIG. 6, each thyroid simulation mechanism 15 of the parathyroid gland preservation box 16 includes multiple preservation cages, and each preservation cage includes two slide rings 151 and multiple protective sheets 152. The two slide rings 151 are sleeved outside the slide column 14, and each protective sheet 152 is divided into an upper protective sheet 1521 and a lower protective sheet 1522. An upper end of the upper protective sheet 1521 is pivotally connected to an upper one of the two slide rings 151, and a lower end of the lower protective sheet 1522 is pivotally connected to a lower one of the two slide rings 151. The upper protective sheet 1521 and the lower protective sheet 1522 are the same in quantity and opposite to each other one by one. A lower end of the upper protective sheet 1521 and an upper end of the lower protective sheet 1522 are pivotally connected to each other through a protective sheet hinge structure 153, so that each preservation cage form a telescopic cage structure.

A slide ring 151 below the preservation cage is fixed on the slide column 14, and a slide ring 151 above the preservation cage is in sliding connection with the slide column 14. A limiting structure is installed on each slide column 14, and is configured to limit a height position of the upper slide ring 151. In an embodiment, the limiting structure is an elastic buckle 141 returnable into the slide column 14. A protective box 18 in a four-leaf petal shape is disposed inside each thyroid simulation mechanism 15 on the slide column 14, and an interior of each petal shape structure is preserved with a parathyroid gland.

The protective sheets 152 can rotate around the slide rings 151. Such a design can bring about the effect that when the protective sheets 152 rotate to a top of the slide rings 151, it means that the preservation cage is opened at a position where the protective sheets 152 is located, and the parathyroid glands can be placed into the protective box 18 at this time. The slide rings 151 can move up and down on the slide column 14, and a spring is disposed in the elastic buckle 141. When the upper slide ring 151 hits the elastic buckle 141, an inner ring of the upper slide ring 151 applies a pressure to the elastic buckle 141. After the elastic buckle 141 is pressed, it is compressed into an inside of the slide column 14, so as to facilitate the upper slide ring 151 to pass through the elastic buckle 141. After the upper slide ring 151 completely passes through the elastic buckle 141, the elastic buckle 141 returns to its original state under the action of elastic force. At this time, the upper slide ring 151 is just on an upper surface of the elastic buckle 141. The elastic buckle 141 applies a supporting force to the upper slide ring 151, overcoming a problem of the upper slide ring 151 falling due to gravity. In this way, the upper slide ring 151 can be kept in this position to achieve the locking effect of the preservation cage. The lower slide ring 151 is in a fixed position, and the preservation cage is tightened by the movement of the upper slide ring 151. Here, the upper and lower slide rings 151 of a preservation cage are selected as an example, and the locking principle of the slide rings 151 of other preservation cages is the same as the principle explained here.

Based on the above structure, when the slide ring 151 on the upper part of the preservation cage moves towards a top of the parathyroid gland protective box 18, the upper protective sheet 1521 and the lower protective sheet 1522 shrink inward due to the movement of the upper slide ring 151, thereby locking the parathyroid gland protective box 18. The purpose of locking the parathyroid gland protective box 18 is that when the parathyroid glands are preserved, and the parathyroid gland protective box 18 is not locked, the parathyroid glands will be free under the action of the preservation fluid, and the free movement will cause collisions between the parathyroid glands, which will damage the structure of the parathyroid glands and is not conducive to the preservation of the parathyroid glands. Therefore, the design of this device can prevent the parathyroid glands from colliding with each other during the preservation process, which is conducive to the preservation of the parathyroid glands from a mechanical point of view.

The preservation cage can preserve four parathyroid glands, and each of the four parathyroid glands has a separate protective box 18, which can ensure that the parathyroid glands in the same preservation cage will not collide. Under the locking effect of the protective sheets 152, the four parathyroid glands will not be free in the preservation liquid, which enhances the stability during the preservation of the parathyroid glands and is conducive to the preservation of the parathyroid glands. Two preservation cages are designed on each slide column 14, and multiple slide columns 14 are combined. Such a design can ensure that a preservation box can store the number of parathyroid glands. This is more advantageous than the traditional preservation device, in which most of the parathyroid glands float in the preservation liquid and cannot be fixed in position, so it is impossible to determine the maximum number of parathyroid glands that can be preserved in a preservation box.

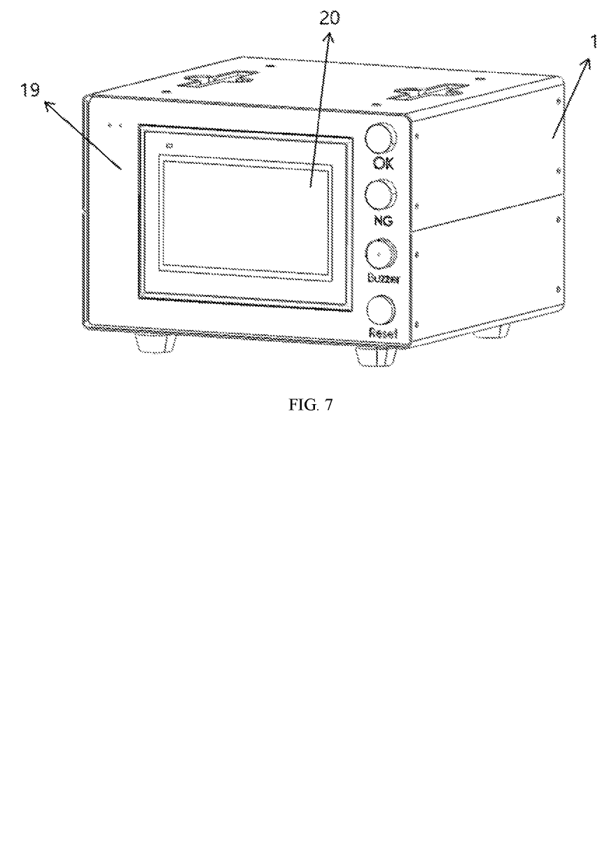

As shown in FIG. 7, the protective case 17 includes a case body 19 and a case door 20. The case door 20 of the protective case 17 can be opened to place the parathyroid glands into the preservation cages, and then the preservation cages are manually locked. After completing the above operations, the preservation liquid is added to implement the preservation of the parathyroid glands. A middle part of the protection case 17 is the preservation part, and the part behind the preservation case is the control system 1 for perfusing the preservation liquid. There is an isolation device between the preservation part and the control system 1, so that they do not affect each other.

The above contents are merely some of the embodiments of the disclosure. For those skilled in the art, many changes can be made in specific implementation methods and application scopes based on ideas of the present technical content. As long as these changes do not deviate from a concept of the disclosure, they all fall within a scope of protection of the disclosure.

What is claimed is:

1. A parathyroid gland perfusion preservation device, comprising:
a parathyroid gland preservation box, defining a space therein for placing isolated parathyroid glands;
a perfusion liquid circulation system, connected to the isolated parathyroid glands stored in the parathyroid gland preservation box through inlet pipes and a reflux pipe to supply perfusion liquid to the isolated parathyroid glands; and
a control system, electrically connected to components of the perfusion liquid circulation system, wherein the control system is configured to receive a working state signal of the components of the perfusion liquid circulation system, and send a control instruction to the components of the perfusion liquid circulation system according to the working state signal;
wherein the parathyroid gland preservation box has a plurality of groups of slide columns and thyroid simulation mechanisms therein, each of the thyroid simulation mechanisms comprises a plurality of preservation cages, each of the plurality of preservation cages comprises two slide rings and a plurality of protective sheets, the two slide rings are sleeved outside a corresponding one of the slide columns, each of the plurality of protective sheets is divided into an upper protective sheet and a lower protective sheet; an upper end of the upper protective sheet is pivotally connected to an upper one of the two slide rings, and a lower end of the lower protective sheet is pivotally connected to a lower one of the two slide rings; and the upper protective sheet and the lower protective sheet are the same in quantity and opposite to each other one by one, and a lower end of the upper protective sheet and an upper end of the lower protective sheet are pivotally connected to each other through a protective sheet hinge structure, so that each of the plurality of preservation cages form a telescopic cage structure; and
wherein a protective box in a four-leaf petal shape is disposed inside each of the thyroid simulation mechanisms on each of the slide columns.

2. The parathyroid gland perfusion preservation device as claimed in claim 1, wherein the perfusion liquid circulation system comprises two circulation pipelines, and the two circulation pipelines comprise a first circulation pipeline and a second circulation pipeline;
the first circulation pipeline is a first inlet pipe, and a first perfusion pump, a defoaming and oxygen exchange component, a first pressure gauge and a first flowmeter are sequentially disposed on the first inlet pipe in that order from a reflux direction to a supply direction; and
the second circulation pipeline is a second inlet pipe, and a second perfusion pump, a defoaming component, a second pressure gauge and a second flowmeter are sequentially disposed on the second inlet pipe in that order from the reflux direction to the supply direction.

3. The parathyroid gland perfusion preservation device as claimed in claim 2, wherein the first circulation pipeline and the second circulation pipeline share the reflux pipe, a thermometer is disposed on the reflux pipe and configured to detect a temperature of refluxed perfusion liquid, and the thermometer is electrically connected to the control system.

4. The parathyroid gland perfusion preservation device as claimed in claim 2, wherein the lower one of the two slide rings below the preservation cage is fixed on the corresponding one of the slide columns, and the upper one of the two slide rings above the preservation cage is in sliding connection with the corresponding one of the slide columns.

5. The parathyroid gland perfusion preservation device as claimed in claim 4, wherein a limiting structure is installed on each of the slide columns, and is configured to limit a height position of the upper one of the two slide rings.

6. The parathyroid gland perfusion preservation device as claimed in claim 5, wherein the limiting structure is an elastic buckle returnable into the slide column.
